(19) United States
(12) Patent Application Publication
(10) Pub. No.: US 2025/0244481 A1
(43) Pub. Date: Jul. 31, 2025

(54) METHOD FOR CALIBRATING PCO AND HARDWARE DELAY OF DOWNLINK NAVIGATION ANTENNA OF LEO SATELLITE

(71) Applicant: National Time Service Center, Chinese Academy of Sciences, Xi'an (CN)

(72) Inventors: Kan Wang, Xi'an (CN); Jiawei Liu, Xi'an (CN); Xuhai Yang, Xi'an (CN)

(21) Appl. No.: 18/649,998

(22) Filed: Apr. 29, 2024

(30) Foreign Application Priority Data
Jan. 25, 2024 (CN) 2024101065401

(51) Int. Cl. G01S 19/02; G01S 19/23

(52) U.S. Cl. CPC G01S 19/02; G01S 19/23

(57) ABSTRACT

A method for calibrating a PCO and a hardware delay of a downlink navigation antenna of an LEO satellite Ls includes: calculating, by using a precise orbit determination and timing result and ground calibrations, a ground calibrated phase center orbit initial value of the downlink navigation antenna and a ground calibrated satellite clock bias initial value; calculating, based on the ground calibrated phase center orbit initial value and the ground calibrated satellite clock bias initial value, a correction amount of the downlink navigation antenna by separating or combining GNSS signals and LEO satellite downlink navigation signals; and correcting, based on the correction amount of the downlink navigation antenna, the PCO of the downlink navigation antenna and the hardware delay of the downlink navigation antenna, so as to realize in-orbit calibration of the PCO of the downlink navigation antenna and the hardware delay of the downlink navigation antenna.

### TECHNICAL FIELD

The disclosure relates to the field of satellite positioning and timing technologies, particularly to a method for calibrating a phase center offset (PCO) and a hardware delay of a downlink navigation antenna of a low-Earth orbit (LEO) satellite.

### BACKGROUND

Due to the lower altitude, higher speed and lower cost of an LEO satellite, the positioning, navigation and timing of an LEO-enhanced global navigation satellite system (GNSS) has a series of advantages, such as stronger signal strength, shorter convergence time and whitened noise of multipath effect. This has attracted more and more attention in recent years. To use LEO navigation signals to realize high-precision LEO enhanced precise point positioning (PPP) and timing on the ground, a series of errors and offsets for a downlink navigation signal line of the LEO satellite need to be accurately calibrated, modeled, or integrated and solved, which include LEO satellite orbits, satellite clock biases, receiver clock bias, tropospheric delay, and various hardware delays.

GNSS satellites often use a lot of ground station observations to perform network solutions to obtain satellite clock biases and satellite orbits. The obtained satellite clock biases often contain an ionosphere-free (IF) code hardware delay of a downlink navigation antenna. When positioning is performed, a ground user only needs to correct the differential code bias (DCB) according to the code observation types used by the ground user.

A ground station network solution method of the LEO satellite is different from a ground station network solution method of the GNSS satellite based on the following reasons: a projection area of the LEO satellite on the Earth is much smaller than that of the GNSS satellite because of a lower orbital height of the LEO satellite, and it is difficult to have continuous ground observation for the LEO satellite even if ground stations are densely built on the ground. Therefore, the solution to a high-precision satellite orbit and a satellite clock bias of the LEO satellite often depends on a spaceborne GNSS observation signal of the LEO satellite, and the LEO satellite uses the spaceborne GNSS observation signal to obtain the high-precision satellite orbit and the satellite clock bias. This directly leads to a problem, that is, a hardware delay of the obtained satellite clock bias is IF code hardware delays of a spaceborne GNSS receiver and a spaceborne GNSS antenna, but not IF code hardware delays of a downlink navigation signal transmitter and a downlink navigation antenna. As such, for the ground user, two types of hardware delay correction are needed to be performed to obtain a traditional satellite clock bias product, so as to carry out subsequent positioning and timing in a traditional positioning way. Specifically, the two types of hardware delay correction include the following steps: deducting the IF code hardware delays of the spaceborne GNSS receiver and the spaceborne GNSS antenna contained in the obtained satellite clock bias, and adding the IF code hardware delays of the downlink navigation signal transmitter and the downlink navigation antenna. Calibration for the two types of hardware delays can be obtained by ground calibration before the LEO satellite is launched into space.

However, because the in-orbit performance and ground performance of related hardware delay calibration may be quite different, to reduce the influence of the corresponding deviation, an in-orbit calibration hardware delay should be used. The IF code hardware delays of the spaceborne GNSS receiver and the spaceborne GNSS antenna can be solved by a spaceborne GNSS signal, while the IF code hardware delays of the downlink navigation signal transmitter and the downlink navigation antenna can only be solved by a corresponding downlink navigation signal received by a ground station. Because of the smaller ground projection area of the LEO satellite and a limited number of ground stations that can receive a downlink navigation signal in the foreseeable short future, it is challenging to solve the IF code hardware delays of the downlink navigation signal transmitter and the downlink navigation antenna.

Similar to the hardware delay, the in-orbit performance and ground performance of a PCO of the downlink navigation antenna of the LEO satellite are likely to be quite different, so it is necessary to use an in-orbit calibration PCO to reduce the bias influence of the PCO. Similarly, the PCO of the downlink navigation antenna of the LEO satellite must be solved by the downlink navigation signal of the LEO satellite received by a ground station, which faces great challenges. At present, the downlink navigation signal of the LEO satellite has not been widely used. To solve the usage problem of the hardware delay and the PCO of the downlink navigation antenna, the simplest and most direct way is to directly use the ground calibrations before the LEO satellite is launched into space.

However, the most direct problem in using the ground calibrations is that it is impossible to capture the changes in the hardware delay and the PCO on the ground and in-orbit, as well as the changes of the hardware delay and the PCO with time and even temperature. In addition, due to the smaller ground projection area of the LEO satellite and the use of cross-antenna hardware delay, an existing method of the GNSS satellite for processing the PCO and the hardware delay of the downlink navigation antennas is not suitable for the LEO satellite.

Therefore, there is an urgent need for a method for calibrating a PCO and a hardware delay of a downlink navigation antenna of an LEO satellite, so as to solve the cross-antenna problem of the satellite hardware delay involved in LEO navigation and the problem that the PCO and the hardware delay are different for the in-orbit calibration and the ground calibration.

### SUMMARY

To solve the above problems in the related art, the disclosure provides a method for calibrating a PCO and a hardware delay of a downlink navigation antenna of an LEO satellite. Technical solutions for the disclosure are as follows.

In the first aspect, the invention provides a method for calibrating a PCO and a hardware delay of a downlink navigation antenna of an LEO satellite Ls, which includes the following steps:
calculating, by using a precise orbit determination and timing result of the LEO satellite Ls and ground calibrations, a ground calibrated phase center orbit initial value of the downlink navigation antenna of the LEO satellite Ls and a ground calibrated satellite clock bias initial value of the LEO satellite Ls;
calculating, based on the ground calibrated phase center orbit initial value and the ground calibrated satellite clock bias initial value, a correction amount of the downlink navigation antenna by separating global navigation satellite system (GNSS) signals of a GNSS system and downlink navigation signals of the LEO satellite Ls, or by combining the GNSS signals of the GNSS system with the downlink navigation signals of the LEO satellite Ls; where the correction amount of the downlink navigation antenna includes: a PCO correction amount, a constant term correction amount of the hardware delay, and a first derivative term correction amount of the hardware delay to a temperature; and
correcting, based on the correction amount of the downlink navigation antenna, the PCO of the downlink navigation antenna of the LEO satellite Ls and the hardware delay of the downlink navigation antenna of the LEO satellite Ls, so as to realize in-orbit calibration of the PCO of the downlink navigation antenna of the LEO satellite Ls and the hardware delay of the downlink navigation antenna of the LEO satellite Ls.

In a second aspect, the disclosure provides a system for calibrating a PCO and a hardware delay of a downlink navigation antenna of an LEO satellite Ls, which includes:
a first calculation module, configured to: calculate, by using a precise orbit determination and timing result of the LEO satellite Ls and ground calibrations, a ground calibrated phase center orbit initial value of the downlink navigation antenna of the LEO satellite Ls and a ground calibrated satellite clock bias initial value of the LEO satellite Ls;
a second calculation module, configured to: calculate, based on the ground calibrated phase center orbit initial value and the ground calibrated satellite clock bias initial value, a correction amount of the downlink navigation antenna by separating GNSS signals of a GNSS system and downlink navigation signals of the LEO satellite Ls, or by combining the GNSS signals of the GNSS system with the downlink navigation signals of the LEO satellite Ls; where the correction amount of the downlink navigation antenna includes: a PCO correction amount, a constant term correction amount of the hardware delay, and a first derivative term correction amount of the hardware delay to a temperature; and
a correction module, configured to: correct, based on the correction amount of the downlink navigation antenna, the PCO of the downlink navigation antenna of the LEO satellite Ls and the hardware delay of the downlink navigation antenna of the LEO satellite Ls, so as to realize in-orbit calibration of the PCO of the downlink navigation antenna of the LEO satellite Ls and the hardware delay of the downlink navigation antenna of the LEO satellite Ls.

The disclosure has at least the following beneficial effects.

According to the disclosure, the ground station capable of receiving the downlink navigation signals of the LEO satellite and the LEO satellite downlink navigation signals received by the ground station are used to perform in-orbit calibration of the PCO of the downlink navigation antenna of the LEO satellite Ls and the hardware delay of the downlink navigation antenna of the LEO satellite Ls by separating GNSS signals of a GNSS system and downlink navigation signals of the LEO satellite Ls, or by combining the GNSS signals of the GNSS system with the downlink navigation signals of the LEO satellite Ls. Specifically, the disclosure takes into account the change of the hardware delay with temperature; by using the temperature of the downlink navigation antenna transmitted by the LEO satellite, the constant term of the hardware delay and the first derivative term of the hardware delay to a temperature are solved, and the in-orbit calibration of the PCO and the hardware delay of the downlink navigation antenna of the LEO satellite is realized, which solves the cross-antenna problem of the satellite hardware delay involved in LEO navigation and the problem that the PCO and the hardware delay are different for the in-orbit calibration and the ground calibration.

The disclosure will be further described in detail with accompanying drawings and specific embodiments.

### BRIEF DESCRIPTION OF DRAWINGS

FIG. 1 illustrates a schematic flow diagram of a method for calibrating a PCO and a hardware delay of a downlink navigation antenna of an LEO satellite according to a first embodiment of the disclosure.

FIG. 2 illustrates a schematic structural block diagram of a system for calibrating a PCO and a hardware delay of a downlink navigation antenna of an LEO satellite according to a second embodiment of the disclosure.

### DETAILED DESCRIPTION OF EMBODIMENTS

The disclosure will be described in further detail with reference to specific embodiments, but embodiments of the disclosure are not limited thereto.

### First Embodiment

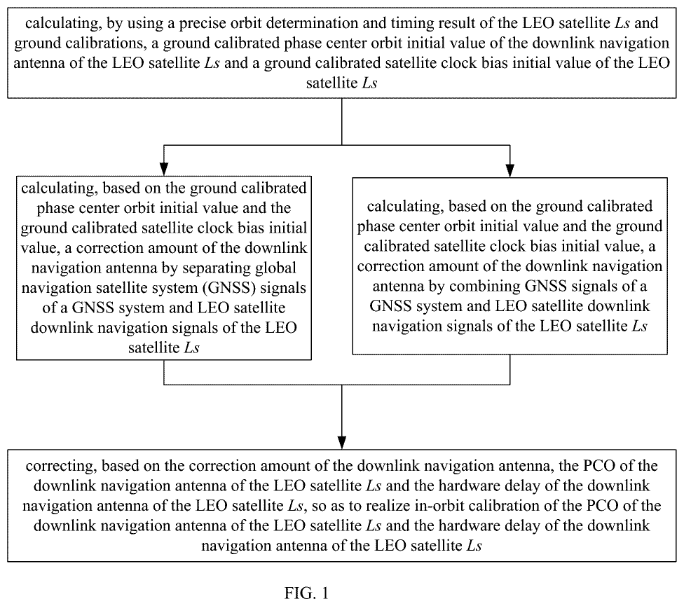

As illustrated in FIG. 1, a schematic flow diagram of a method for calibrating a PCO and a hardware delay of a downlink navigation antenna of an LEO satellite according to a first embodiment of the disclosure is provided. The method for calibrating the PCO and the hardware delay of the downlink navigation antenna of the LEO satellite includes the following steps 1-3.

In the step 1, a phase ground calibrated center orbit initial value of the downlink navigation antenna of the LEO satellite Ls and a ground calibrated satellite clock bias initial value of the LEO satellite Ls are calculated by using a precise orbit determination and timing result of the LEO satellite Ls and ground calibrations.

In an embodiment, post-processed precise orbit determination and timing is performed by using spaceborne GNSS observation signals of the LEO satellite Ls to obtain the precise orbit determination and timing result of the LEO satellite Ls, and the ground calibrated phase center orbit initial value of the downlink navigation antenna of the LEO satellite Ls in an Earth-centered Earth-fixed (ECEF) system and the ground calibrated satellite clock bias initial value obtained by various hardware delay correction are obtained according to the precise orbit determination and timing result of the LEO satellite Ls, a series of ground hardware calibrations of the LEO satellite Ls, and an in-orbit calibrated PCO and an in-orbit calibrated code hardware delay of a spaceborne GNSS antenna of the LEO satellite Ls. In an embodiment, the ground calibrated phase center orbit initial value \hat{x}^{Ls0} of the downlink navigation antenna of the LEO satellite Ls is obtained by using a formula (1) expressed as follows:

$${\hat{x}}^{Ls 0} = {\hat{x}}_{APC}^{Ls} - {R}_{NEUG 2 ECEF} Δ {\hat{x}}_{PCO , GNSS}^{Ls} - {R}_{B 2 ECEF} Δ {x}_{CoM 2 ARPG}^{Ls} + {R}_{B 2 ECEF} Δ {x}_{CoM 2 ARP}^{Ls} + {R}_{NEU 2 ECEF} Δ {x}_{PCO}^{Ls 0} , \qquad ( 1 )$$

where \hat{x}_{APC}^{Ls} represents a phase center orbit of a spaceborne GNSS antenna of the LEO satellite Ls, which is obtained through post-processed precise orbit determination and timing; Δ\hat{x}_{PCO,GNSS}^{Ls} represents an in-orbit calibrated PCO of the spaceborne GNSS antenna of the LEO satellite Ls under a spaceborne GNSS antenna coordinate system (north, east and up); Δx_{CoM2ARPG}^{Ls} represents a ground calibrated vector from a mass center of the LEO satellite Ls to an antenna reference point (ARP) of the spaceborne GNSS antenna under a spacecraft body fixed (SBF) system; Δx_{CoM2ARP}^{Ls} represents a ground calibrated vector from the mass center of the LEO satellite Ls to an ARP of the downlink navigation antenna under the SBF system; Δx_{PCO}^{Ls0} represents a ground calibrated PCO of the downlink navigation antenna of the LEO satellite Ls under a downlink navigation antenna coordinate system; R_{NEUG2ECEF} represents a rotation matrix from the spaceborne GNSS antenna coordinate system to an Earth-centered Earth-fixed (ECEF) system; R_{NEU2ECEF} represents a rotation matrix from the downlink navigation antenna coordinate system to the ECEF; and R_{B2ECEF} represents a rotation matrix from the SBF system to the ECEF system.

In an embodiment, R_{NEUG2ECEF} is obtained through a formula (2) and R_{NEU2ECEF} is obtained through a formula (3):

$${R}_{NEUG 2 ECEF} = {R}_{B 2 ECEF} {R}_{NEUG 2 B} , \qquad ( 2 )$$

$${R}_{NEU 2 ECEF} = {R}_{B 2 ECEF} {R}_{NEU 2 B} , \qquad ( 3 )$$

where R_{NEUG2B} represents a rotation matrix from the spaceborne GNSS antenna coordinate system to the SBF system, which depends on an installation direction of the spaceborne GNSS antenna on the LEO satellite Ls; and R_{NEU2B} represents a rotation matrix from the downlink navigation antenna coordinate system to the SBF system, which depends on an installation direction of the downlink navigation antenna on the LEO satellite Ls.

In an embodiment, R_{B2ECEF} is obtained through a formula (4):

$${R}_{B 2 ECEF} = {R}_{ECI 2 ECEF} {R}_{B 2 ECI} , \qquad ( 4 )$$

where R_{ECI2ECEF} represents a rotation matrix from an inertial coordinate system, such as J2000.0 to the ECEF system; and R_{B2ECI} represents a rotation matrix from the SBF to the inertial coordinate system, which can be obtained by using attitude quaternions q₀, q₁, q₂, and q₃ through a formula (5):

$${R}_{B 2 ECI} = ( \begin{matrix}1 - 2 \times ( {q}_{2}^{2} + {q}_{3}^{2} ) & 2 \times ( {q}_{1} {q}_{2} - {q}_{0} {q}_{3} ) & 2 \times ( {q}_{1} {q}_{3} + {q}_{0} {q}_{2} ) \\ 2 \times ( {q}_{1} {q}_{2} + {q}_{0} {q}_{3} ) & 1 - 2 \times ( {q}_{1}^{2} + {q}_{3}^{2} ) & 2 \times ( {q}_{2} {q}_{3} - {q}_{0} {q}_{1} ) \\ 2 \times ( {q}_{1} {q}_{3} - {q}_{0} {q}_{2} ) & 2 \times ( {q}_{2} {q}_{3} + {q}_{0} {q}_{1} ) & 1 - 2 \times ( {q}_{1}^{2} + {q}_{2}^{2} )\end{matrix} ) . \qquad ( 5 )$$

The ground calibrated satellite clock bias initial value [symbol] at time tᵢ is obtained through a formula (6):

$$d {\hat{{t}^{⌣}}}^{Ls 0} ( {t}_{i} ) = d {\hat{\tilde{t}}}^{Ls} ( {t}_{i} ) + \frac{{d}_{IF}^{Ls 0} + Δ {T}^{Ls} ( {t}_{i} ) {\dot{d}}_{IF}^{Ls 0} - {\hat{d}}_{IF , GNSS}^{Ls}}{c} , \qquad ( 6 )$$

where [symbol] (tᵢ) represents an LEO satellite clock bias of the LEO satellite Ls at the time tᵢ, which is obtained through post-processed precise orbit determination and timing; \hat{d}_{IF,GNSS}^{Ls} represents an ionosphere-free (IF) code hardware delay of the GNSS system corresponding to an in-orbit calibration satellite clock bias parameter; d_{IF}^{LS0} represents a ground calibrated constant term of the hardware delay of the downlink navigation antenna of the LEO satellite Ls; \dot{d}_{IF}^{Ls0} represents a ground calibrated first derivative term of the hardware delay of the downlink navigation antenna of the LEO satellite Ls to the temperature; ΔT^{Ls}(tᵢ) represents a temperature change of the downlink navigation antenna of the LEO satellite Ls at the time tᵢ; and c represents the speed of light.

It should be noted that it is assumed that the IF code hardware delay of the downlink navigation antenna of the LEO satellite Ls varies linearly with the temperature, so the above-mentioned specific temperature is a corresponding temperature after the temperature changes. The change of the IF code hardware delay of the spaceborne GNSS antenna with temperature is not considered here, and it is combined with the change of the IF code hardware delay of the downlink navigation antenna with the temperature in the subsequent solution.

In step 2, based on the ground calibrated phase center orbit initial value and the ground calibrated satellite clock bias initial value, a correction amount of the downlink navigation antenna is calculated by separating GNSS signals of a GNSS satellite and downlink navigation signals of the LEO satellite Ls, or by combining the GNSS signals of the GNSS satellite with the downlink navigation signals of the LEO satellite Ls.

Specifically, after calculating the ground calibrated phase center orbit initial value of the downlink navigation antenna of the LEO satellite Ls and the ground calibrated satellite clock bias initial value of the LEO satellite, the disclosure provides two ways to solve the correction amount of the downlink navigation antenna. The first way of the two ways is separating the GNSS signals and the LEO satellite downlink navigation signals, and the second way of the two ways is combining the GNSS signals with the LEO satellite downlink navigation signals. These two ways are introduced in detail below.

In an embodiment, in step 2, in a situation where the correction amount of the downlink navigation antenna is calculated based on the ground calibrated phase center orbit initial value and the ground calibrated satellite clock bias initial value by separating the GNSS signals and the LEO satellite downlink navigation signals, the calculating, based on the ground calibrated phase center orbit initial value and the ground calibrated satellite clock bias initial value, the correction amount of the downlink navigation antenna by separating the GNSS signals and the LEO satellite downlink navigation signals specifically includes the following steps 21-23.

In step 21, precise point positioning (PPP) is performed using the GNSS signals received by a ground station r to obtain a ground station coordinate of the ground station r, a receiver clock bias of a ground station receiver of the ground station r, and a tropospheric zenith wet delay.

In an embodiment, the receiver clock bias includes a real receiver clock bias and an IF code hardware delay of the GNSS system of the ground station receiver.

Specifically, precise point positioning is performed on each static ground station by using a batch least squares adjustment based on at least 24-hour data of the GNSS signals on at least two frequencies received by the static ground station, a GNSS satellite post-processed precise orbit, a GNSS satellite clock bias and a differential code bias (DCB), to thereby obtain the ground station coordinate \hat{x}ᵣ of the ground station r, the receiver clock bias [symbol] for each epoch, and the tropospheric zenith wet delay every N hours. In an embodiment, N may be set to 2 on a test day when the humidity changes slowly.

It should be noted that in the description of the disclosure, all parameters marked with a mark [symbol] indicate the estimated values of the corresponding parameters below the mark.

In addition, it should be noted that the receiver clock bias [symbol] includes an IF code hardware delay d_{IF,G} of a GNSS system (for example, global positioning system (GPS)) of the ground station receiver, and the receiver clock bias [symbol] is specifically expressed through a formula (7):

$$E ( Δ {{\hat{\tilde{t}}}^{}}_{r} ) = {dt}_{r} + \frac{{d}_{IF , G}}{c} , \qquad ( 7 )$$

where E( ) represents an expected value, and dtᵣ represents the real receiver clock bias.

In step 22, based on the ground station coordinate, the receiver clock bias, the tropospheric zenith wet delay, the ground calibrated phase center orbit initial value, and the ground calibrated satellite clock bias initial value, a first observation equation group of IF code and carrier phase observations from the downlink navigation antenna of the LEO satellite Ls is constructed.

Specifically, through combining the parameters solved in step 1 and step 21, a corresponding downlink navigation signal observation equation group (i.e., the first observation equation group) of the LEO satellite Ls is established, which is used for obtaining the correction amount of the downlink navigation antenna.

Assuming that the downlink navigation signals of the LEO satellite Ls is a dual-frequency signal, a difference Δp_{r,IF}^{Ls}, i.e., an observed-minus-computed (O-C) term, between an observed value and a computed value of the IF code observation and a difference Δφ_{r,IF}^{Ls}, i.e., an O-C term, between an observed value and a computed value of a carrier phase observation at the time tᵢ can be expressed by the following observation equations (i.e., the first observation equation group):

$$E ( Δ {p}_{r , IF}^{Ls} ( {t}_{i} ) ) = {( {μ}_{r}^{Ls} ( {t}_{i} ) )}^{T} {R}_{NEU 2 ECEF} ( {t}_{i} ) δ {x}_{PCO}^{Ls} - ( δ {\tilde{d}}_{IF}^{Ls} + Δ {T}^{Ls} ( {t}_{i} ) δ {\dot{d}}_{F}^{Ls} ) , \qquad ( 8 )$$

$$E ( {Δφ}_{r , IF}^{Ls} ( {t}_{i} ) ) = {λ}_{IF 1} {\tilde{N}}_{r , IF}^{Ls} + {( {μ}_{r}^{Ls} ( {t}_{i} ) )}^{T} {R}_{NEU 2 ECEF} ( {t}_{i} ) δ {x}_{PCO}^{L} , \qquad ( 9 )$$

where E( [symbol] ) represents an expected value; tᵢ represents time; Δp_{r,IF}^{Ls} represents an O-C term of the IF code observation, Δφ_{r,IF}^{Ls} represents an O-C term of the carrier phase observation; μᵣ^{Ls}, represents a unit direction vector from the LEO satellite Ls to the ground station r; ( [symbol] )^{T} represents a transposition operation; and δx_{PCO}^{Ls} represents a difference between an in-orbit calibrated IF PCO of the downlink navigation antenna of the LEO satellite Ls and a ground calibrated IF PCO of the downlink navigation antenna of the LEO satellite Ls, that is, the PCO correction amount; δ\dot{d}_{IF}^{Ls} represents a difference between an in-orbit calibrated first derivative term of the IF code hardware delay of the downlink navigation antenna of the LEO satellite Ls to a temperature and a ground calibrated first derivative term of the IF code hardware delay of the downlink navigation antenna of the LEO satellite Ls to a temperature, that is, the first derivative term correction amount of the hardware delay to the temperature. λ_{IF1} represents an IF combined wavelength of the downlink navigation signals of the LEO satellite Ls, and Ñ_{r,IF}^{Ls} r,IF represents an IF combined float-valued ambiguity of the downlink navigation signals of the LEO satellite Ls.

It should be noted that, because the receiver clock bias [symbol] corrected by substituting the O-C term contains the IF code hardware delay of the GNSS system, as shown in the formula (7), a correction amount δ\tilde{d}_{IF}^{Ls} of a hardware delay constant term of the LEO satellite Ls not only includes a difference ILS between a constant term of an in-orbit calibration IF code hardware delay and a constant term of a ground-calibration IF code hardware delay of the downlink navigation antenna of the LEO satellite Ls, but also includes a difference between an IF code hardware delay of the ground station receiver to the GNSS signals of the GNSS system and an IFcode hardware delay of the ground station receiver to the downlink navigation signals of the LEO satellite Ls, which is expressed through a formula (10):

$$δ {\tilde{d}}_{IF}^{Ls} = δ {d}_{IF}^{Ls} - {d}_{IF} + {d}_{IF , G} , \qquad ( 10 )$$

where d_{IF} represents the IF code hardware delay of the ground station receiver to the downlink navigation signals of the LEO satellite Ls; and d_{IF,G} represents the IF code hardware delay of the ground station receiver to the GNSS signals of the system G.

In an embodiment, the unit direction vector μᵣ^{Ls} from the LEO satellite Ls to the ground station r at the time tᵢ may be expressed through a formula (11):

$${μ}_{r}^{Ls} ( {t}_{i} ) = \frac{{\hat{x}}_{r} - {\hat{x}}^{Ls 0} ( {t}_{i} )}{‖ {\hat{x}}_{r} - {\hat{x}}^{Ls 0} ( {t}_{i} ) ‖} . \qquad ( 11 )$$

In an embodiment, the IF combined float-valued ambiguity Ñ_{r,IF}^{Ls} of the downlink navigation signals of the LEO satellite Ls may be expressed through a formula (12):

$${\tilde{N}}_{r , IF}^{Ls} = {N}_{r , IF}^{Ls} + \frac{{δ}_{r , IF} - {δ}_{IF}^{Ls} - {d}_{IF , G}}{{λ}_{IF 1}} , \qquad ( 12 )$$

where N_{r,IF}^{Ls} represents the true IF ambiguity, δ_{r,IF} represents a carrier phase hardware delay of the ground station r, and δ_{IF}^{Ls} represents a carrier phase hardware delay of the LEO satellite Ls.

In step 23, the first observation equation group is solved to obtain the correction amount of the downlink navigation antenna.

Specifically, based on the above-mentioned first observation equation group, a solved value δ\hat{x}_{PCO}^{Ls} of the PCO correction amount, a resolved value [symbol] of the constant term correction amount of the hardware delay of the LEO satellite Ls, and a solved value [symbol] of the first derivative term correction amount of the hardware delay to the temperature can be solved by the batch least square adjustment, and a detailed solution process can be realized with reference to the existing related technologies, which will not be repeated herein.

In an embodiment, in step 2, in a situation where the correction amount of the downlink navigation antenna is calculated based on the ground calibrated phase center orbit initial value and the ground calibrated satellite clock bias initial value by combining the GNSS signals and the LEO satellite downlink navigation signals, the calculating, based on the ground calibrated phase center orbit initial value and the ground calibrated satellite clock bias initial value, the correction amount of the downlink navigation antenna by combining the GNSS signals and the LEO satellite downlink navigation signals specifically includes the following 2a and 2b.

In step 2a, based on the GNSS signals and the LEO satellite downlink navigation signals received by a ground station, a second observation equation group of IF code and carrier phase observations of each of the GNSS system and the LEO satellite Ls is constructed.

Specifically, in step 2, the GNSS signals of the GNSS satellite Gs and the downlink navigation signals of the LEO satellite Ls are combined to jointly solve a series of ground station related parameters and in-orbit calibration parameters. It is assumed that a ground station coordinate xᵣ of the ground station is known and will not be solved.

In an embodiment, an observation equation group of IF code and carrier phase observations of each of the GNSS system and the LEO satellite Ls (that is, the second observation equation group) may be expressed through formulas (13)-(16):

$$E ( Δ {p}_{r , IF}^{Gs} ( {t}_{i} ) ) = c \times Δ {\tilde{t}}_{r} ( {t}_{i} ) + {g}_{r}^{Gs} ( {t}_{i} ) \times {τ}_{r} , \qquad ( 13 )$$

$$E ( {Δφ}_{r , IF}^{Gs} ( {t}_{i} ) ) = c \times Δ {\tilde{t}}_{r} ( {t}_{i} ) + {g}_{r}^{Gs} ( {t}_{i} ) \times {τ}_{r} + {λ}_{IF 2} {\tilde{N}}_{r , IF}^{Gs} , \qquad ( 14 )$$

$$E ( Δ {p}_{r , IF}^{Ls} ( {t}_{i} ) ) = c \times Δ {\tilde{t}}_{r} ( {t}_{i} ) + {g}_{r}^{Ls} ( {t}_{i} ) \times {τ}_{r} + {( {μ}_{r}^{Ls} ( {t}_{i} ) )}^{T} {R}_{NEU 2 ECEF} ( {t}_{i} ) δ {x}_{PCO}^{Ls} - ( δ {\tilde{d}}_{IF}^{Ls} + Δ {T}^{Ls} ( {t}_{i} ) δ {\dot{d}}_{IF}^{Ls} ) , \qquad ( 15 )$$

$$E ( {Δφ}_{r , IF}^{Ls} ( {t}_{i} ) ) = c \times Δ {\tilde{t}}_{r} ( {t}_{i} ) + {g}_{r}^{Ls} ( {t}_{i} ) \times {τ}_{r} + {λ}_{IF 1} {\tilde{N}}_{r , IF}^{Ls} + {( {μ}_{r}^{Ls} ( {t}_{i} ) )}^{T} {R}_{NEU 2 ECEF} ( {t}_{i} ) δ {x}_{PCO}^{Ls} , \qquad ( 16 )$$

where E( ) represents an expected value; tᵢ represents time; Δp_{r,IF}^{Gs} represents an O-C term of the IF code observation of the GNSS satellite Gs of the system G; Δφ_{r,IF}^{Gs} represents an O-C term of the carrier phase observation of the GNSS satellite Gs of the system G; c represents the speed of light; Δp_{r,IF}^{Ls} represents an O-C term of the IF code observation of the downlink navigation antenna of the LEO satellite Ls; Δφ_{r,IF}^{Ls} represents an O-C term of the carrier phase observation of the downlink navigation antenna of the LEO satellite Ls; gᵣ^{Gs} represents a mapping function of a tropospheric zenith wet delay to a direction of the GNSS signals of the GNSS satellite Gs; gᵣ^{Ls} represents a mapping function of the tropospheric zenith wet delay to a direction of the downlink navigation signals of the LEO satellite Ls; τᵣ represents the tropospheric zenith wet delay; λ_{IF2} represents an IF combined wavelength of the two frequencies used for the system G; Ñ_{r,IF}^{Gs} represents an IF combined float-valued ambiguity of the GNSS satellite Gs; δx_{PCO}^{Ls} represents the PCO correction amount; δ\tilde{d}_{IF}^{Ls} represents the constant term correction amount of the hardware delay; and δ\dot{d}_{IF}^{Ls} represents the first derivative term correction amount of the hardware delay to the temperature.

The IF combined float-valued ambiguity Ñ_{r,IF}^{Gs} of the GNSS satellite Gs is expressed through a formula (17):

$${\tilde{N}}_{r , IF}^{Gs} = {N}_{r , IF}^{Gs} + \frac{{δ}_{r , IF} - {δ}_{IF}^{Gs} - {d}_{IF , G}}{{λ}_{IF 2}} , \qquad ( 17 )$$

where δ_{IF}^{Gs} represents a carrier phase hardware delay of the GNSS satellite Gs.

The other related parameters in the formula (17) are the same as above, and will not be repeated herein.

It should be noted that when solving a multi-GNSS system, the second observation equation group further includes formulas (18) and (19):

$$E ( Δ {p}_{r , IF}^{Ms} ( {t}_{i} ) ) = c \times Δ {\tilde{t}}_{r} ( {t}_{i} ) + {g}_{r}^{Ms} ( {t}_{i} ) \times {τ}_{r} + {d}_{IF , GM} , \qquad ( 18 )$$

$$E ( {Δφ}_{r , IF}^{Ms} ( {t}_{i} ) ) = c \times Δ {\tilde{t}}_{r} ( {t}_{i} ) + {g}_{r}^{Ms} ( {t}_{i} ) \times {τ}_{r} + {λ}_{IF 3} {\tilde{N}}_{r , IF}^{Ms} . \qquad ( 19 )$$

The above formulas show that when a system M is added to the original system G, the second observation equation group needs to be added correspondingly. Δp_{r,IF}^{Ms} represents an O-C term of an IF code observation of a GNSS satellite Ms of the system M; Δφ_{r,IF}^{Ms} represents an O-C term of a carrier phase observation of the GNSS satellite Ms; gᵣ^{Ms} represents a mapping function of the tropospheric zenith wet delay to the signal direction of the GNSS satellite Ms; d_{IF,GM} represents a difference between an IF code hardware delay of a ground station receiver of the system G and an IF code hardware delay of a ground station receiver of the system M; λ_{IF3} represents an IF combined wavelength of two frequencies used for the system M; and Ñ_{r,IF}^{Ms} represents an IF combined float-valued ambiguity of the GNSS satellite Ms.

Because the receiver clock bias Δ\tilde{t}ᵣ contains the IF code hardware delay of the ground station receiver of the GNSS satellite Gs, a new parameter d_{IF,GM} needs to be solved. d_{IF,GM} represents a difference between the IF code hardware delay of the ground station receiver of the system M and the IF coded hardware delay of the ground station receiver of the system G, namely:

$${d}_{IF , GM} = {d}_{IF , M} - {d}_{IF , G} . \qquad ( 20 )$$

Similarly, the receiver clock bias Δ\tilde{t}ᵣ of the second observation equation group also contains the IF code hardware delay d_{IF,G} of the ground station receiver of GNSS satellite Gs. Based on this, the IF combined float-valued ambiguity Ñ_{r,IF}^{Ms} in the second observation equation group of the satellite Ms is transformed through a formula (21):

$${\tilde{N}}_{r , IF}^{Ms} = {N}_{r , IF}^{Ms} + \frac{{δ}_{r , IF} - {δ}_{IF}^{Ms} - {d}_{IF , G}}{{λ}_{IF 3}} , \qquad ( 21 )$$

where δ_{IF}^{Ms} represents a carrier phase hardware delay of a satellite Ls of the GNSS satellite Ms.

In step 2b, the second observation equation group is solved to obtain the correction amount of the downlink navigation antenna.

Specifically, based on the above-mentioned second observation equation group, a solved value δ\hat{x}_{PCO}^{Ls} of the PCO correction amount, a resolved value [symbol] of the constant term correction amount of the hardware delay of the LEO satellite Ls, and a solved value [symbol] of the first derivative term correction amount of the hardware delay to the temperature can be solved by the batch least square adjustment, and a detailed solution process can be realized with reference to the existing related technologies, which will not be repeated herein.

In step 3, the PCO of the downlink navigation antenna of the LEO satellite Ls and the hardware delay of the downlink navigation antenna of the LEO satellite Ls are corrected based on the correction amount of the downlink navigation antenna, so as to realize in-orbit calibration of the PCO and the hardware delay of the downlink navigation antenna of the LEO satellite Ls.

Specifically, formulas for correcting the PCO of the downlink navigation antenna of the LEO satellite Ls and the hardware delay of the downlink navigation antenna of the LEO satellite Ls are as follows:

$$Δ {\hat{x}}_{PCO}^{Ls} = Δ {\hat{x}}_{PCO}^{Ls 0} + δ {\hat{x}}_{PCO}^{Ls} , \qquad ( 22 )$$

$${\tilde{d}}_{IF}^{Ls} = {d}_{IF}^{Ls 0} + δ {\hat{\tilde{d}}}_{IF}^{Ls} , \qquad ( 23 )$$

$${\dot{d}}_{IF}^{Ls} = {\dot{d}}_{IF}^{Ls 0} + δ {\hat{\dot{d}}}_{IF}^{Ls} , \qquad ( 24 )$$

where Δ\hat{x}_{PCO}^{Ls} represents a solved value of an in-orbit calibrated PCO of the downlink navigation antenna of the LEO satellite Ls; Δ\hat{x}_{PCO}^{Ls0} represents a calibrated value of a ground calibrated PCO under a downlink navigation antenna coordinate system of the LEO satellite Ls; δ\hat{x}_{PCO}^{Ls} represents a solved value of the PCO correction amount; \tilde{d}_{IF}^{Ls} represents an in-orbit calibrated constant term of the hardware delay of the downlink navigation antenna of the LEO satellite Ls; d_{IF}^{Ls0} represents a ground calibrated constant term of the hardware delay of the downlink navigation antenna of the LEO satellite Ls; [symbol] represents a resolved value of the constant term correction amount of the hardware delay; \dot{d}_{IF}^{Ls} represents an in-orbit calibrated first derivative term of the hardware delay of the downlink navigation antenna of the LEO satellite Ls to a temperature; \dot{d}_{IF}^{Ls0} represents a ground calibrated first derivative term of the hardware delay of the downlink navigation antenna of the LEO satellite Ls to a temperature; and [symbol] represents a solved value of the first derivative term correction amount of the hardware delay to the temperature.

It should be noted that [symbol] contains the difference between the IF code hardware delay of the ground station receiver to the GNSS signals of the GNSS system and the IF code hardware delay of the ground station receiver to the downlink navigation signals of the LEO satellite Ls, (see the formula (10)), so the in-orbit calibrated constant term \tilde{d}_{IF}^{Ls} of the hardware delay of the downlink navigation antenna of the LEO satellite Ls also contains this difference, and an expected value the hardware delay of the downlink navigation antenna is not the true value of the in-orbit hardware delay of the downlink navigation antenna of the LEO satellite Ls.

According to the disclosure, the ground station capable of receiving the downlink navigation signals of the LEO satellite and the LEO satellite downlink navigation signals received by the ground station are used to perform in-orbit calibration of the PCO of the downlink navigation antenna of the LEO satellite Ls and the hardware delay of the downlink navigation antenna of the LEO satellite Ls by separating GNSS signals and LEO satellite downlink navigation signals, or by combining the GNSS signals with the LEO satellite downlink navigation signals. Specifically, the disclosure takes into account the change of the hardware delay with temperature; by using the temperature of the downlink navigation antenna transmitted by the LEO satellite, the constant term of the hardware delay and the first derivative term of the hardware delay to a temperature are solved, and the in-orbit calibration of the PCO and the hardware delay of the downlink navigation antenna of the LEO satellite is realized, which solves the cross-antenna problem of the satellite hardware delay involved in LEO navigation and the problem that the PCO and the hardware delay are different for the in-orbit calibration and the ground calibration.

### Second Embodiment

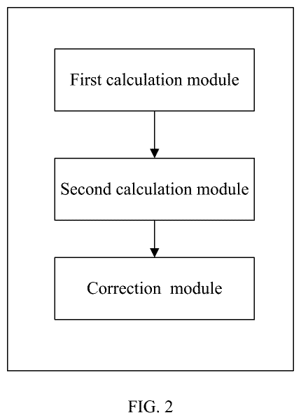

Based on the first embodiment and the same inventive concept, the second embodiment provides a system for calibrating a PCO and a hardware delay of a downlink navigation antenna of an LEO satellite. As illustrated in FIG. 2, a schematic structural block diagram of a system for calibrating a PCO and a hardware delay of a downlink navigation antenna of an LEO satellite according to the second embodiment of the disclosure is provided. The system for calibrating the PCO and the hardware delay of the downlink navigation antenna of the LEO satellite Ls specifically includes a first calculation module, a second calculation module, and a correction module.

The first calculation module is configured: calculate, by using a precise orbit determination and timing result of the LEO satellite Ls and ground calibrations, a ground calibrated phase center orbit initial value of the downlink navigation antenna of the LEO satellite Ls and a ground calibrated satellite clock bias initial value of the LEO satellite Ls.

The second calculation module is configured to: calculate, based on the ground calibrated phase center orbit initial value and the ground calibrated satellite clock bias initial value, a correction amount of the downlink navigation antenna by separating GNSS signals and LEO satellite downlink navigation signals, or by combining the GNSS signals with the LEO satellite downlink navigation signals; wherein the correction amount of the downlink navigation antenna comprises: a PCO correction amount, a constant term correction amount of the hardware delay, and a first derivative term correction amount of the hardware delay to a temperature.

In an embodiment, the correction amount of the downlink navigation antenna includes a PCO correction amount, a constant term correction amount of the hardware delay to a temperature and a first derivative term correction amount of the hardware delay to temperature.

The correction module is configured to: correct, based on the correction amount of the downlink navigation antenna, the PCO of the downlink navigation antenna of the LEO satellite Ls and the hardware delay of the downlink navigation antenna of the LEO satellite Ls, so as to realize in-orbit calibration of the PCO of the downlink navigation antenna of the LEO satellite Ls and the hardware delay of the downlink navigation antenna of the LEO satellite Ls.

It should be noted that the above modules are embodied by a software stored in at least one memory and executable by at least one processor.

The system for calibrating a PCO and a hardware delay of a downlink navigation antenna of an LEO satellite provided in the second embodiment can realize the method for calibrating a PCO and a hardware delay of a downlink navigation antenna of an LEO satellites provided in the first embodiment, and the detailed process can refer to the first embodiment, so it is not repeated herein.

Therefore, the system can also achieve the in-orbit calibration of the PCO and the hardware delay of the downlink navigation antenna of the LEO satellite by using the LEO satellite downlink navigation signals received by the ground station, which solves the cross-antenna problem of the satellite hardware delay involved in LEO navigation and the problem that the PCO and the hardware delay are different for the in-orbit calibration and the ground calibration.

The above is a further detailed description of the disclosure combined with specific embodiments, and it cannot be considered that the specific implementation of the disclosure is limited to these descriptions. For ordinary technicians in the technical field to which the disclosure belongs, several simple deductions or substitutions can be made without departing from the concept of the disclosure, all of which should be regarded as belonging to the scope of protection of the disclosure.

What is claimed is:

1. A method for calibrating a phase center offset (PCO) and a hardware delay of a downlink navigation antenna of a low-Earth orbit (LEO) satellite Ls, comprising:
calculating, by using a precise orbit determination and timing result of the LEO satellite Ls and ground calibrations, a ground calibrated phase center orbit initial value of the downlink navigation antenna of the LEO satellite Ls and a ground calibrated satellite clock bias initial value of the LEO satellite Ls;
calculating, based on the ground calibrated phase center orbit initial value and the ground calibrated satellite clock bias initial value, a correction amount of the downlink navigation antenna by separating global navigation satellite system (GNSS) signals of a GNSS system and LEO satellite downlink navigation signals of the LEO satellite Ls, or by combining the GNSS signals of the GNSS system with the LEO satellite downlink navigation signals of the LEO satellite Ls; wherein the correction amount of the downlink navigation antenna comprises: a PCO correction amount, a constant term correction amount of the hardware delay, and a first derivative term correction amount of the hardware delay to a temperature; and
correcting, based on the correction amount of the downlink navigation antenna, the PCO of the downlink navigation antenna of the LEO satellite Ls and the hardware delay of the downlink navigation antenna of the LEO satellite Ls, so as to realize in-orbit calibration of the PCO of the downlink navigation antenna of the LEO satellite Ls and the hardware delay of the downlink navigation antenna of the LEO satellite Ls.

2. The method for calibrating the PCO and the hardware delay of the downlink navigation antenna of the LEO satellite Ls as claimed in claim 1, wherein the ground calibrated phase center orbit initial value \hat{x}^{Ls0} of the downlink navigation antenna of the LEO satellite Ls is calculated through the following formula:
$${\hat{x}}^{Ls 0} = {\hat{x}}_{APC}^{Ls} - {R}_{NEUG 2 ECEF} Δ {\hat{x}}_{PCO , GNSS}^{Ls} - {R}_{B 2 ECEF} Δ {x}_{CoM 2 ARPG}^{Ls} + {R}_{B 2 ECEF} Δ {x}_{CoM 2 ARP}^{Ls} + {R}_{NEU 2 ECEF} Δ {x}_{PCO}^{Ls 0} ,$$
where \hat{x}_{APC}^{Ls} represents a phase center orbit of a spaceborne GNSS antenna of the LEO satellite Ls, which is obtained through post-processed precise orbit determination and timing; Δ\hat{x}_{PCO,GNSS}^{Ls} represents an in-orbit calibrated PCO of the spaceborne GNSS antenna of the LEO satellite Ls under a spaceborne GNSS antenna coordinate system; Δx_{CoM2ARPG}^{Ls} represents a ground calibrated vector from a mass center of the LEO satellite Ls to an antenna reference point (ARP) of the spaceborne GNSS antenna under a spacecraft body fixed (SBF) system; Δx_{CoM2ARP}^{Ls} represents a ground calibrated vector from the mass center of the LEO satellite Ls to an ARP of the downlink navigation antenna under the SBF system; Δx_{PCO}^{Ls0} represents a ground calibrated PCO of the downlink navigation antenna of the LEO satellite Ls under a downlink navigation antenna coordinate system; R_{NEUG2ECEF} represents a rotation matrix from the spaceborne GNSS antenna coordinate system to an Earth-centered Earth-fixed (ECEF) system; R_{NEU2ECEF} represents a rotation matrix from the downlink navigation antenna coordinate system to the ECEF; and R_{B2ECEF} represents a rotation matrix from the SBF system to the ECEF system;
wherein the ground calibrated satellite clock bias initial value [symbol] ^{Ls0} at time tᵢ is obtained through the following formula:
$$d {\hat{{t}^{⌣}}}^{Ls 0} ( {t}_{i} ) = d {\hat{\tilde{t}}}^{Ls} ( {t}_{i} ) + \frac{{d}_{IF}^{Ls 0} + Δ {T}^{Ls} ( {t}_{i} ) {\dot{d}}_{IF}^{Ls 0} - {\hat{d}}_{IF , GNSS}^{Ls}}{c} ,$$
where [symbol] ^{Ls}(tᵢ) represents an LEO satellite clock bias of the LEO satellite Ls at the time tᵢ, which is obtained through post-processed precise orbit determination and timing; \hat{d}_{IF,GNSS}^{Ls} represents an ionosphere-free (IF) code hardware delay of the GNSS system corresponding to an in-orbit calibration satellite clock bias parameter; d_{IF}^{Ls0} represents a ground calibrated constant term of the hardware delay of the downlink navigation antenna of the LEO satellite Ls, \dot{d}_{IF}^{Ls0} represents a ground calibrated first derivative term of the hardware delay of the downlink navigation antenna of the LEO satellite Ls to the temperature; ΔT^{Ls}(tᵢ) represents a temperature change of the downlink navigation antenna of the LEO satellite Ls at the time tᵢ; and c represents a speed of light.

3. The method for calibrating the PCO and the hardware delay of the downlink navigation antenna of the LEO satellite Ls as claimed in claim 2, wherein in a situation where the correction amount of the downlink navigation antenna is calculated based on the ground calibrated phase center orbit initial value and the ground calibrated satellite clock bias initial value by separating the GNSS signals of the GNSS system and the LEO satellite downlink navigation signals of the LEO satellite Ls, the calculating, based on the ground calibrated phase center orbit initial value and the ground calibrated satellite clock bias initial value, the correction amount of the downlink navigation antenna by separating the GNSS signals of the GNSS system and the LEO satellite downlink navigation signals of the LEO satellite Ls specifically comprises:
performing precise point positioning (PPP) using the GNSS signals received by a ground station r to obtain a ground station coordinate of the ground station r, a receiver clock bias of a ground station receiver of the ground station r, and a tropospheric zenith wet delay, wherein the receiver clock bias comprises a real receiver clock bias and an IF code hardware delay of the GNSS system of the ground station receiver;
constructing, based on the ground station coordinate, the receiver clock bias, the tropospheric zenith wet delay, the ground calibrated phase center orbit initial value, and the ground calibrated satellite clock bias initial value, a first observation equation group of IF code and carrier phase observations from the downlink navigation antenna of the LEO satellite Ls; and
solving the first observation equation group to obtain the correction amount of the downlink navigation antenna.

4. The method for calibrating the PCO and the hardware delay of the downlink navigation antenna of the LEO satellite Ls as claimed in claim 3, wherein the first observation equation group is expressed as follows:
$$E ( Δ {p}_{r , IF}^{Ls} ( {t}_{i} ) ) = {( {μ}_{r}^{Ls} ( {t}_{i} ) )}^{T} {R}_{NEU 2 ECEF} ( {t}_{i} ) δ {x}_{PCO}^{Ls} - ( δ {\tilde{d}}_{IF}^{Ls} + Δ {T}^{Ls} ( {t}_{i} ) δ {\dot{d}}_{IF}^{Ls} ) ,$$
$$E ( {Δφ}_{r , IF}^{Ls} ( {t}_{i} ) ) = {λ}_{IF 1} {\tilde{N}}_{r , IF}^{Ls} + {( {μ}_{r}^{Ls} ( {t}_{i} ) )}^{T} {R}_{NEU 2 ECEF} ( {t}_{i} ) δ {x}_{PCO}^{Ls} ,$$
where E( ) represents an expected value; tᵢ represents time; Δp_{r,IF}^{Ls} represents an observed-minus-computed (O-C) term of the IF code observation; Δφ_{r,IF}^{Ls} represents an O-C term of the carrier phase observation; μᵣ^{Ls} represents a unit direction vector from the LEO satellite Ls to the ground station r; ( )^{T} represents a transposition operation; and δx_{PCO}^{Ls} represents a difference between an in-orbit calibrated IF PCO of the downlink navigation antenna of the LEO satellite Ls and a ground calibrated IF PCO of the downlink navigation antenna of the LEO satellite Ls, that is, the PCO correction amount;
wherein δ\tilde{d}_{IF}^{Ls} represents the constant term correction amount of the hardware delay, which is calculated through the following formula:
$$δ {\tilde{d}}_{IF}^{Ls} = δ {d}_{IF}^{Ls} - {d}_{IF} + {d}_{IF , G} ;$$
wherein δd_{IF}^{Ls} represents a difference between an in-orbit calibrated constant term of an IF code hardware delay of the downlink navigation antenna of the LEO satellite Ls and a ground-calibrated constant term of the IF code hardware delay of the downlink navigation antenna of the LEO satellite Ls; d_{IF} represents an IF code hardware delay of the ground station receiver to the downlink navigation signals of the LEO satellite Ls; and d_{IF,G} represents an IF code hardware delay of the ground station receiver to the GNSS signals of a system G of the GNSS system;
wherein δ\dot{d}_{IF}^{Ls} represents a difference between an in-orbit calibrated first derivative term of the IF code hardware delay of the downlink navigation antenna of the LEO satellite Ls to a temperature and a ground calibrated first derivative term of the IF code hardware delay of the downlink navigation antenna of the LEO satellite Ls to a temperature, that is, the first derivative term correction amount of the hardware delay to the temperature; and
wherein λ_{IF1} represents an IF combined wavelength of the downlink navigation signals of the LEO satellite Ls, and Ñ_{r,IF}^{Ls} represents an IF combined float-value ambiguity of the downlink navigation signals of the LEO satellite Ls.

5. The method for calibrating the PCO and the hardware delay of the downlink navigation antenna of the LEO satellite Ls as claimed in claim 2, wherein in a situation where the correction amount of the downlink navigation antenna is calculated based on the ground calibrated phase center orbit initial value and the ground calibrated satellite clock bias initial value by combining the GNSS signals of the GNSS system and the LEO satellite downlink navigation signals of the LEO satellite Ls, the calculating, based on the ground calibrated phase center orbit initial value and the ground calibrated satellite clock bias initial value, the correction amount of the downlink navigation antenna by combining the GNSS signals and the LEO satellite downlink navigation signals of the LEO satellite Ls specifically comprises:
constructing, based on the GNSS signals and the LEO satellite downlink navigation signals of the LEO satellite Ls received by a ground station, a second observation equation group of IF code and carrier phase observations of each of the GNSS system and the LEO satellite Ls; and
solving the second observation equation group, to obtain the correction amount of the downlink navigation antenna.

6. The method for calibrating the PCO and the hardware delay of the downlink navigation antenna of the LEO satellite Ls as claimed in claim 5, wherein the second observation equation group is expressed as follows:
$$E ( Δ {p}_{r , IF}^{Gs} ( {t}_{i} ) ) = c \times Δ {\tilde{t}}_{r} ( {t}_{i} ) + {g}_{r}^{Gs} ( {t}_{i} ) \times {τ}_{r} ;$$
$$E ( {Δφ}_{r , IF}^{Gs} ( {t}_{i} ) ) = c \times Δ {\tilde{t}}_{r} ( {t}_{i} ) + {g}_{r}^{Gs} ( {t}_{i} ) \times {τ}_{r} + {λ}_{IF 2} {\tilde{N}}_{r , IF}^{Gs} ;$$
$$E ( Δ {p}_{r , IF}^{Ls} ( {t}_{i} ) ) = c \times Δ {\tilde{t}}_{r} ( {t}_{i} ) + {g}_{r}^{Ls} ( {t}_{i} ) \times {τ}_{r} + {( {μ}_{r}^{Ls} ( {t}_{i} ) )}^{T} {R}_{NEU 2 ECEF} ( {t}_{i} ) δ {x}_{PCO}^{Ls} - ( δ {\tilde{d}}_{IF}^{Ls} + Δ {T}^{Ls} ( {t}_{i} ) δ {\dot{d}}_{IF}^{Ls} ) ;$$
$$E ( {Δφ}_{r , IF}^{Ls} ( {t}_{i} ) ) = c \times Δ {\tilde{t}}_{r} ( {t}_{i} ) + {g}_{r}^{Ls} ( {t}_{i} ) \times {τ}_{r} + {λ}_{IF 1} {\tilde{N}}_{r , IF}^{Ls} + {( {μ}_{r}^{Ls} ( {t}_{i} ) )}^{T} {R}_{NEU 2 ECEF} ( {t}_{i} ) δ {x}_{PCO}^{Ls} ;$$
where E( ) represents an expected value; tᵢ represents time; Δp_{r,IF}^{Gs} represents an O-C term of the IF code observation of a GNSS satellite Gs of the system G; Δφ_{r,IF}^{Gs} represents an O-C term of the carrier phase observation of the GNSS satellite Gs of the system G; c represents a speed of light; Δ\tilde{t}ᵣ represents a receiver clock bias of a ground station receiver of the ground station; gᵣ^{Gs} represents a mapping function of a tropospheric zenith wet delay to the GNSS signals of the GNSS satellite Gs; T, represents the tropospheric zenith wet delay; λ_{IF2} represents an IF combined wavelength of two frequencies used for the system G; and Ñ_{r,IF}^{Gs} represents an IF combined float-value ambiguity of the GNSS satellite Gs;
wherein Δp_{r,IF}^{Ls} represents an O-C term of the IF code observation of the downlink navigation antenna of the LEO satellite Ls; Δφ_{r,IF}^{Ls} represents an O-C term of the carrier phase observation of the downlink navigation antenna of the LEO satellite Ls; gᵣ^{Ls} represents a mapping function of the tropospheric zenith wet delay to a direction of the downlink navigation signals of the LEO satellite Ls; ( )^{T} represents a transposition operation; and δx_{PCO}^{Ls} represents a difference between an in-orbit calibrated IF PCO of the downlink navigation antenna of the LEO satellite Ls and a ground calibrated IF PCO of the downlink navigation antenna of the LEO satellite Ls, that is, the PCO correction amount;
wherein δ\tilde{d}_{IF}^{Ls} represents the constant term correction amount of the hardware delay, which is calculated through the following formula:
$$δ {\tilde{d}}_{IF}^{Ls} = δ {d}_{IF}^{Ls} - {d}_{IF} + {d}_{IF , G} ;$$
wherein δd_{IF}^{Ls} represents a difference between an in-orbit calibrated constant term of an IF code hardware delay of the downlink navigation antenna of the LEO satellite Ls and a ground-calibrated constant term of the IF code hardware delay of the downlink navigation antenna of the LEO satellite Ls; d_{IF} represents an IF code hardware delay of the ground station receiver to the downlink navigation signals of the LEO satellite Ls; and d_{IF,G} represents an IF code hardware delay of the ground station receiver to the GNSS signals of the system G;
wherein δ\dot{d}_{IF}^{Ls} represents a difference between an in-orbit calibrated first derivative term of the IF code hardware delay of the downlink navigation antenna of the LEO satellite Ls to a temperature and a ground calibrated first derivative term of the IF code hardware delay of the downlink navigation antenna of the LEO satellite Ls to a temperature, that is, the first derivative term correction amount of the hardware delay to the temperature; and
wherein λ_{IF1} represents an IF combined wavelength of the downlink navigation signals of the LEO satellite Ls, and Ñ_{r,IF}^{Ls} represents an IF combined float-value ambiguity of the downlink navigation signals of the LEO satellite Ls.

7. The method for calibrating the PCO and the hardware delay of the downlink navigation antenna of the LEO satellite Ls as claimed in claim 6, wherein in a situation that the GNSS system further comprises a system M containing a GNSS satellite Ms, the second observation equation group further comprises:
$$E ( Δ {p}_{r , IF}^{Ms} ( {t}_{i} ) ) = c \times Δ {\tilde{t}}_{r} ( {t}_{i} ) + {g}_{r}^{Ms} ( {t}_{i} ) \times {τ}_{r} + {d}_{IF , GM} ;$$
$$E ( {Δφ}_{r , IF}^{Ms} ( {t}_{i} ) ) = c \times Δ {\tilde{t}}_{r} ( {t}_{i} ) + {g}_{r}^{Ms} ( {t}_{i} ) \times {τ}_{r} + {λ}_{IF 3} {\tilde{N}}_{r , IF}^{Ms} ,$$
where Δp_{r,IF}^{Ms} represents an O-C term of an IF code observation of the GNSS satellite Ms Δφ_{r,IF}^{Ms} represents an O-C term of a carrier phase observation of the GNSS satellite Ms; gᵣ^{Ms} represents a mapping function of the tropospheric zenith wet delay to a direction of the GNSS signals of the GNSS satellite Ms; d_{IF,GM} represents a difference between an IF code hardware delay of a ground station receiver of the system G and an IFcode hardware delay of a ground station receiver of the system M; λ_{IF3} represents an IF combined wavelength of two frequencies used for the system M; and Ñ_{r,IF}^{Ms} represents an IF combined float-value ambiguity of the GNSS satellite Ms of the system M.

8. The method for calibrating the PCO and the hardware delay of the downlink navigation antenna of the LEO satellite Ls as claimed in claim 1, wherein formulas for correcting the PCO of the downlink navigation antenna of the LEO satellite Ls and the hardware delay of the downlink navigation antenna of the LEO satellite Ls are as follows:
$$Δ {\hat{x}}_{PCO}^{Ls} = Δ {\hat{x}}_{PCO}^{Ls 0} + δ {\hat{x}}_{PCO}^{Ls}$$
$${\tilde{d}}_{IF}^{Ls} = {d}_{IF}^{Ls 0} + δ {\hat{\tilde{d}}}_{IF}^{Ls}$$
$${\dot{d}}_{IF}^{Ls} = {\dot{d}}_{IF}^{Ls 0} + δ {\hat{\dot{d}}}_{IF}^{Ls}$$
where Δ\hat{x}_{PCO}^{Ls} represents a solved value of an in-orbit calibrated PCO of the downlink navigation antenna of the LEO satellite Ls; ALSO Δ\hat{x}_{PCO}^{Ls0} represents a calibrated value of a ground calibrated PCO under a downlink navigation antenna coordinate system of the LEO satellite Ls; δ\hat{x}_{PCO}^{Ls} represents a solved value of the PCO correction amount; \tilde{d}_{IF}^{Ls} represents an in-orbit calibrated constant term of the hardware delay of the downlink navigation antenna of the LEO satellite Ls; d_{IF}^{Ls0} represents a ground calibrated constant term of the hardware delay of the downlink navigation antenna of the LEO satellite Ls; [symbol] represents a resolved value of the constant term correction amount of the hardware delay; \dot{d}_{IF}^{Ls} represents an in-orbit calibrated first derivative term of the hardware delay of the downlink navigation antenna of the LEO satellite Ls to a temperature; \dot{d}_{IF}^{Ls0} represents a ground calibrated first derivative term of the hardware delay of the downlink navigation antenna of the LEO satellite Ls to a temperature; and [symbol] represents a solved value of the first derivative term correction amount of the hardware delay to the temperature.

9. A system for calibrating a PCO and a hardware delay of a downlink navigation antenna of an LEO satellite Ls, comprising:
a first calculation module, configured to: calculate, by using a precise orbit determination and timing result of the LEO satellite Ls and ground calibrations, a ground calibrated phase center orbit initial value of the downlink navigation antenna of the LEO satellite Ls and a ground calibrated satellite clock bias initial value of the LEO satellite Ls;
a second calculation module, configured to: calculate, based on the ground calibrated phase center orbit initial value and the ground calibrated satellite clock bias initial value, a correction amount of the downlink navigation antenna by separating GNSS signals and downlink navigation signals of the LEO satellite Ls, or by combining the GNSS signals with the downlink navigation signals of the LEO satellite Ls; wherein the correction amount of the downlink navigation antenna comprises: a PCO correction amount, a constant term correction amount of the hardware delay, and a first derivative term correction amount of the hardware delay to a temperature; and
a correction module, configured to: correct, based on the correction amount of the downlink navigation antenna, the PCO of the downlink navigation antenna of the LEO satellite Ls and the hardware delay of the downlink navigation antenna of the LEO satellite Ls, so as to realize in-orbit calibration of the PCO of the downlink navigation antenna of the LEO satellite Ls and the hardware delay of the downlink navigation antenna of the LEO satellite Ls.
